(19) United States
(12) Patent Application Publication
(10) Pub. No.: US 2024/0248210 A1
(43) Pub. Date: Jul. 25, 2024

(54) TWO-WAY FREQUENCY EXCHANGE BETWEEN INDEPENDENTLY MOVING OSCILLATORS

(71) Applicant: Agalti Corporation, Longmont, CO (US)

(72) Inventor: Jeremy Dean Warriner, Longmont, CO (US)

(21) Appl. No.: 18/156,083

(22) Filed: Jan. 18, 2023

(51) Int. Cl. G01S 17/74

(52) U.S. Cl. CPC G01S 17/74

(57) ABSTRACT

A method for estimating an operating parameter of a remote reference oscillator on a remote platform relative to a local reference oscillator on a local platform, both platforms moving independently, may be used to estimate a slant-range velocity, relative frequency, or relative gravitational potential between the two platforms. The method includes generating local and remote reference frequencies on the local and remote platforms, respectively, and sending them to the other platform. A locally received frequency can be determined by the local platform and a remotely received frequency may be determined by the remote platform. These collection of the transmitted and received frequencies between the platforms are used to estimate the operating parameter.

### BACKGROUND

The ability to determine the slant-range velocity and relative frequency between two oscillators on independently moving platforms enables many applications in the fields of navigation and time-keeping where a priori knowledge of the platform motion is not available. For instance, autonomous vehicles may use the slant-range velocity to determine the relative closing speed between two vehicles, Global Navigation Satellite Systems (GNSS) might use the relative frequency information to maintain syntonization between satellite oscillators, or tactical radios might use both the slant-range velocity and frequency information to provide coordination of movement and electronic effects between multiple vehicles.

While various two-way frequency transfer methods are known in the prior art, they are either fundamentally a variant of two-way time transfer methods or rely on the assumption that the two oscillators are not moving with respect to one another. This method, however, uses only the exchange of frequency measurements between the two oscillators and allows the oscillators to move independently of one another. It represents the most analogous relationship to Einstein's method of two-way time transfer, but exchanges frequency measurements as opposed to time measurements. Relative motion of the platforms is, however, a significant complicating factor due to the Doppler effect on the frequency of signals transmitted between moving platforms.

### SUMMARY

In a first aspect, a method for estimating an operating parameter of a remote reference oscillator on a remote platform relative to a local reference oscillator on a local platform, both platforms moving independently includes generating a local reference frequency f_{local} on the local platform using the local reference oscillator; generating a transmitted frequency f_{tx.local} based at least in part on f_{local}; sending the transmitted frequency f_{tx.local} to the remote platform where it is received as f_{rx.remote} by the remote platform, where f_{rx.remote} is relatable to the reference frequency fᵣₑₘₒₜₑ of the remote reference oscillator; generating a remote reference frequency fᵣₑₘₒₜₑ on the remote platform using the remote reference oscillator; generating a transmitted frequency f_{tx.remote} based at least in part on fᵣₑₘₒₜₑ; sending the transmitted frequency f_{tx.remote}, to the local platform where it is received as f_{rx.local} by the local platform and where f_{rx.local} is relatable to the reference frequency f_{local} of the local reference oscillator; determining, by the local platform, a locally transmitted frequency FoT_{local} and a locally received frequency FoA_{local}, both measured with respect to the local reference oscillator f_{local}; determining, by the remote platform, a remotely transmitted frequency FOTᵣₑₘₒₜₑ and a remotely received frequency FoAᵣₑₘₒₜₑ, both measured with respect to the remote reference oscillator fᵣₑₘₒₜₑ; collecting the information determined by the local platform FoT_{local} and FoA_{local} and the information determined by the remote platform FOTᵣₑₘₒₜₑ and FoAᵣₑₘₒₜₑ in a common location; and estimating the operating parameter between f_{local} and fᵣₑₘₒₜₑ from FOT_{local}, FOA_{local}, FOTᵣₑₘₒₜₑ, and FoAᵣₑₘₒₜₑ.

In further aspects, a slant-range velocity, a relative frequency, and the relative gravitational field between the two platforms may be determined from the operating parameter.

### BRIEF DESCRIPTION OF THE DRAWINGS

FIG. 1 is a schematic diagram of a system of two-way frequency exchange, in an embodiment.

FIG. 2 illustrates an example of the motion of two independently moving oscillators.

FIG. 3 illustrates the angle between the line-of-sight to the opposite platform and the net velocity of the platforms from the local platform's perspective.

FIG. 4 illustrates the angle between the line-of-sight to the opposite platform and the net velocity of the platforms from the remote platform's perspective.

FIG. 5 is a flowchart of a method of estimating an operating parameter of a remote reference oscillator on a remote platform to a local reference oscillator on a local platform, both moving independently, in embodiments.

### DETAILED DESCRIPTION OF THE EMBODIMENTS

Two-Way Frequency Exchange (TWFE) is a method and system for estimating the slant-range velocity, relative frequency, or relative gravitational potential of two oscillators located on independently moving platforms. The process consists of transmitting and receiving signals between the two platforms, measuring the relative frequency between the transmitted and received signal at each platform, and exchanging that measurement with the opposite platform. Each platform is then independently able to determine the slant-range velocity, relative frequency, or relative gravitational potential of the reference oscillator on the opposite platform with respect to the reference oscillator on its local platform.

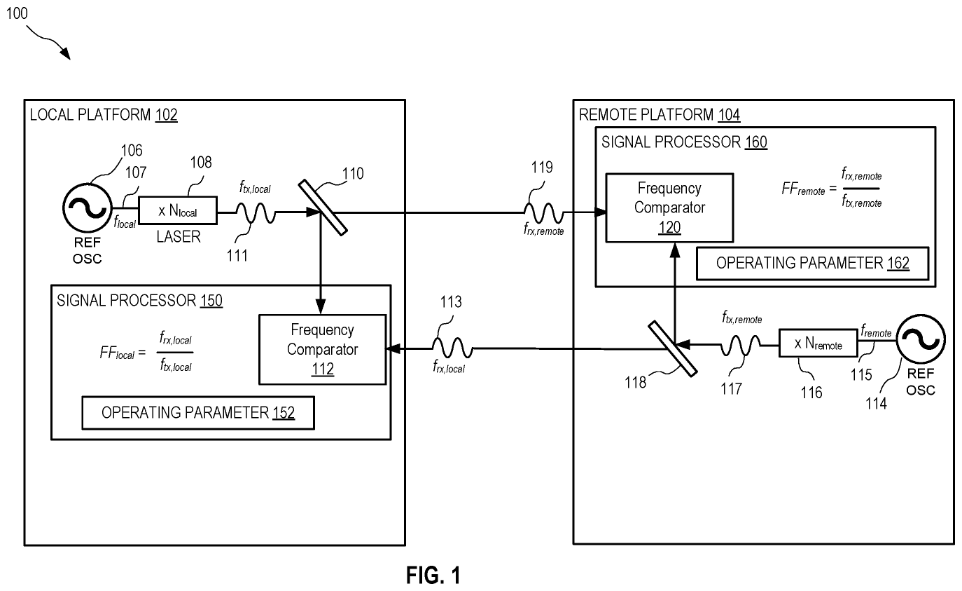

FIG. 1 is a schematic diagram of a system 100 for TWFE. As shown, TWFE is a symmetric process. For purposes of illustration, the platforms are differentiated by labeling one platform as local platform 102 and the other as remote platform 104. It should be noted, however, that the labeling of the platforms is arbitrary and both platforms may consider themselves the local platform for determining the opposite platform's operating parameter relative to itself. This arbitrary assignment of labels is simply a matter of perspective and is useful in providing a more intuitive description of the TWFE system.

FIG. 1 illustrates an exemplar setup for performing Two-Way Frequency Exchange. Not all system components typical of a real-world system (e.g., filters, amplifiers) are shown but the diagram includes attributes of the platforms for illustrating principles of embodiments disclosed herein. Of note, the relation between the transmitted and received frequency on a given platform 102 or 104 is known or measured with respect to a common oscillator. A real-world system may have multiple frequency conversions or other system components/oscillators, but if the translations in frequency can be described as a function of reference oscillator 106, the TWFE system enables the determination of the slant-range velocity, relative frequency, or relative gravitational potential of reference oscillator 114 on the remote platform.

From FIG. 1, the transmit frequency of local platform 102 may be expressed as a function of output 107 of local reference oscillator 106, defining frequency f_{local}. A laser 108 is frequency locked to a reference oscillator 106 via output 107 and is used to generate transmitted signal 111 having a frequency f_{tx,local} which is relatable to the frequency f_{local}. Transmitted signal 111 is then sampled. For example, transmitted signal 111 may be split using a semi-transparent mirror 110 so that the received signal 113, denoted as f_{rx,local} and received from remote platform 104 may be compared relative to the locally transmitted signal 111 using a frequency comparator 112. Frequency comparator 112 may be a component of a signal processor 150, which may be a signal processor having machine readable instructions that, when executed by the processor 150, cause the signal processor 150 to perform the functionality discussed herein, including but not limited to comparison of transmitted signal 111 and received signal 113 to estimate an operating parameter 152 of remote platform 104.

The process is symmetric in that each platform must be able to relate the frequency of the received emission to its transmitted emission and each platform must be able to provide that relation to the opposite platform. In remote platform 104, output 115 of local reference oscillator 114 defines a transmit frequency fᵣₑₘₒₜₑ. Output 115 is used to control laser 116 such that laser 116 is frequency locked to the reference oscillator 114 to generate the transmitted signal 117 having a frequency f_{tx,remote} which is relatable to the frequency fᵣₑₘₒₜₑ. The transmitted signal 117 is then sampled. For example, transmitted signal 117 is split using a semi-transparent mirror 118 so that the received signal 119 from local platform 102 may be compared relative to the remotely transmitted signal 117 using frequency comparator 120. Frequency comparator 120 may be a component of a processor 160, which may be a signal processor having machine readable instructions that, when executed by the processor 160, cause the processor 160 to perform the functionality discussed herein, including but not limited to comparison of transmitted signal 117 and received signal 119 to estimate an operating parameter 162 of local platform 102.

The measurements described above are then collected at a common location. This may be accomplished by modulating data on the locally transmitted signal 111 and the remotely transmitted signal 117 such that both platforms 102 and 104 have the measurements from the opposite platform. However, there may be operating scenarios where the exchange of measurements is not reciprocal and only one platform is able to calculate the operating parameter of interest. Furthermore, there may be scenarios where the measurements are collected by a system outside of the two platforms 102 and 104. Regardless of how the measurement information is transported, the method requires only that the measurement information be collected in one or more locations such that the operating parameter of interest may be determined.

The measured or known quantities in FIG. 1 are denoted using capital letters and consist of the fractional frequency measurements (FF_{local} and FFᵣₑₘₒₜₑ) made by each platform and the frequency multipliers (N_{local} and Nᵣₑₘₒₜₑ) for each platform that relate the frequency of the transmitted signal to the frequency of the reference oscillator. Given these quantities, operating parameters 152 and 162 may include one or more of the slant-range velocity, relative frequency, or relative gravitational potential of the opposite platform's oscillator. For example, operating parameter 152 may define one or more of the slant-range velocity, relative frequency, or relative gravitational potential of remote oscillator 114 with respect to local oscillator 106, and operating parameter 162 may define the one or more of the slant-range velocity, relative frequency, or relative gravitational potential of local oscillator 106 with respect to remote oscillator 114. The relative frequency and slant-range velocity parameters are estimated as a function of FF_{local}, FFᵣₑₘₒₜₑ, N_{local}, and Nᵣₑₘₒₜₑ as given by Eq. 1 and Eq. 2 respectively and where c is the speed of light constant. The relative gravitational potential is presented later after a substitution of variables is made.

$$\hat{ff} ( {FF}_{local} , {FF}_{remote} , {N}_{local} , {N}_{remote} ) = \frac{{N}_{local}}{{N}_{remote}} \sqrt{\frac{F {F}_{local}}{F {F}_{remote}}} \qquad Eq . 1$$

$$\hat{sv} ( {FF}_{local} , {FF}_{remote} , {N}_{local} , {N}_{remote} ) = \frac{1 - F {F}_{local} F {F}_{remote}}{1 + F {F}_{local} F {F}_{remote}} c \qquad Eq . 2$$

The system illustrated in FIG. 1 is an optical system using lasers, however, the methodology applies equally well to Radio Frequency (RF) systems. A RF system would differ from an optical system only in the hardware used to construct the embodiment. For instance, an RF system may use phase locked loops, frequency mixers, and digitizers to relate the transmitted frequency 111 and received frequency 113 to the reference oscillator 106. The key characteristic of all embodiments is that the transmitted frequency and received frequency are described or measured with respect to the reference oscillator on the respective platform. More generalized equations for determining the desired operating parameter with respect to the transmitted and received frequencies of each platform will be presented below. Here, the equations for the illustrated system will be derived from physical principles so that users of the method may properly understand their embodiment and any limitations thereof.

In FIG. 1, physical quantities are denoted using lower-case variables. The frequency of the transmitted signal 111 (ƒ_{tx.local}) and received signal 113 (ƒ_{rx.local}) at the local platform 102 and the transmitted signal 117 (ƒ_{tx.remote}) and received signal 119 (ƒ_{rx.remote}) at the remote platform 104 are related to the fractional frequency measurements (FF_{local}, FFᵣₑₘₒₜₑ) made by the signal processor 150 and the signal processor 160 respectively as given by Eq. 3 and Eq. 4.

$${FF}_{local} = \frac{{f}_{rx , local}}{{f}_{tx , local}} \qquad Eq . 3$$

$${FF}_{remote} = \frac{{f}_{rx , remote}}{{f}_{tx , remote}} \qquad Eq . 4$$

For each platform, the relation between the transmitted frequencies (ƒ_{tx.local}, ƒ_{tx.remote}) and the frequency of the reference oscillators (ƒ_{local}, ƒᵣₑₘₒₜₑ) is determined by the frequency conversion process. For the illustrated system, those relationships are given by Eq. 5 and Eq. 6.

$${f}_{tx , local} = {N}_{local} {f}_{local} \qquad Eq . 5$$

$${f}_{tx , remote} = {N}_{remote} {f}_{remote} \qquad Eq . 6$$

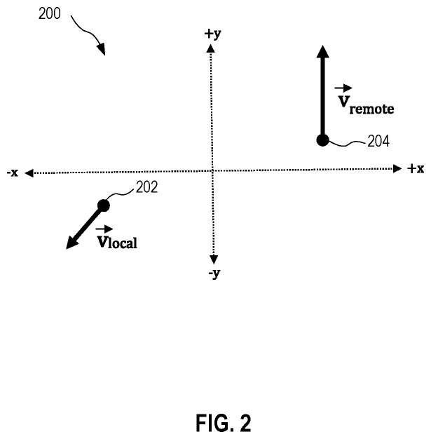

FIG. 2 illustrates an example of the motion of two independently moving oscillators 202 and 204 with respect to a common reference frame 200. Each oscillator's velocity is described as a vector and denoted as local or remote to identify which oscillator's motion the velocity vector describes. In embodiments, oscillator 202 is an example of oscillator 106 on local platform 102 and oscillator 204 is an example of oscillator 114 on remote platform 104.

The final set of system relations given by Eq. 7 and Eq. 8, relates the frequency transmitted by one platform to the frequency received by the opposite platform. It is noted that there are two types of effects that create a frequency shift in the signal as it transits between the platforms. The first is the relative motion of the platforms themselves and the second is the change due to details of the path the signal travels (such as changes in gravitational potential).

$${f}_{rx . local} = \frac{( 1 + z )}{γ ( 1 + β cos {θ}_{local} )} {f}_{tx . remote} \qquad Eq . 7$$

$${f}_{rx . remote} = \frac{( 1 - z )}{γ ( 1 + β cos {θ}_{remote} )} {f}_{tx . local} \qquad Eq . 8$$

Where γ is the Lorentz factor, β is the ratio of the relative oscillator velocities to the speed of light (c), and z is the redshift induced by the signal path. It is interesting to note that the β term impacts both transiting signals in the same way (because the relative motion between the platforms is the same for both signals), whereas the z term is equal in magnitude but opposite in sign for the two transiting signals. Meaning that the signal traveling from the local platform to the remote platform will experience a frequency shift factor that is equal in magnitude, but opposite in sign, to the frequency shift factor for the signal traveling from the remote platform to the local platform. In other words, one of the signals will experience a redshift and the other will experience a blueshift. The redshift term z is these equations is defined such that z is positive if a signal transiting from the local platform to the remote platform experienced a redshift.

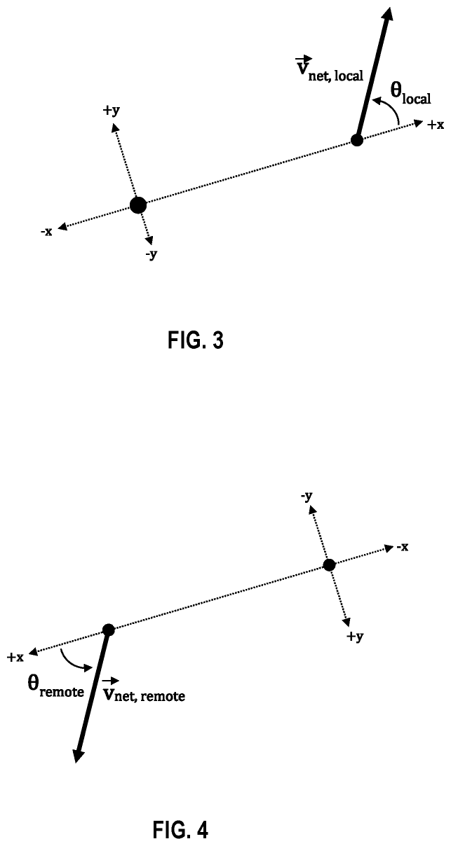

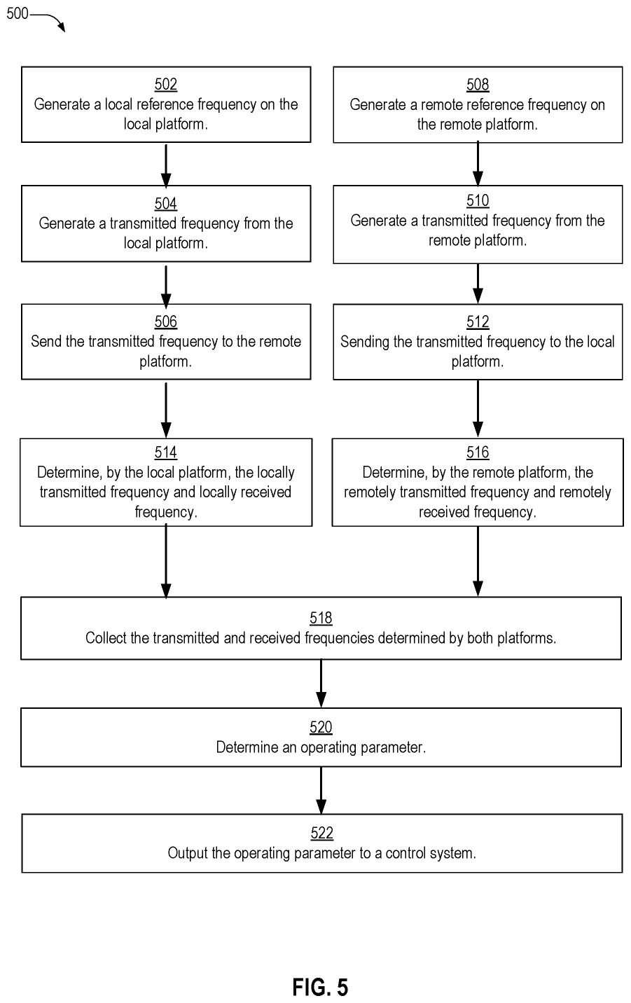

To understand θ_{local} and θᵣₑₘₒₜₑ, it is useful to refer to FIG. 3 and FIG. 4, respectively. Each of these figures illustrates the scenario in FIG. 2 from the perspective of the platform making the measurement. In each case, the net velocity vector \vec{v}net is a physical quantity described by subtracting the platform's velocity from the opposite platform's velocity. For FIG. 5, this relation is given by:

$${\vec{v}}_{net , local} = {\vec{v}}_{remote} - {\vec{v}}_{local} \qquad Eq . 9$$

And for FIG. 4, this relation is given by:

$${\vec{v}}_{net , remote} = {\vec{v}}_{local} - {\vec{v}}_{remote} \qquad Eq . 10$$

For each perspective, the reference frame is defined by the observed line-of-sight of the signal propagating from the opposite platform. The θ term is the angle between that line-of-sight and the net velocity of the platforms. While from the diagrams it appears as though this angle is the same, the angle is different due to the effects of relativistic aberration. For reference, some useful relations are provided here:

$$‖ {\vec{v}}_{net , local} ‖ = ‖ {\vec{v}}_{net , remote} ‖ = v \qquad Eq . 11$$

$$β = \frac{v}{c} \qquad Eq . 12$$

$$γ = \frac{1}{\sqrt{1 - {β}^{2}}} \qquad Eq . 13$$

$$cos {θ}_{remote} = \frac{cos {θ}_{local} + β}{1 + β cos {θ}_{local}} \qquad Eq . 14$$

### Determining Slant-Range Velocity

As discussed above, the operating parameters 152, 162 may include slant-range velocity. One example of calculating the slant-range velocity is provided below and implemented by processors 152, 160. For the local platform, substituting Eq. 7 into Eq. 3 yields the following:

$${FF}_{local} = \frac{{f}_{rx , local}}{{f}_{tx , local}} = \frac{\frac{( 1 + z )}{γ ( 1 + β cos {θ}_{local} )} {f}_{tx , remote}}{{f}_{tx , local}} \qquad Eq . 15$$

And substituting Eq. 5 and Eq. 6 into Eq. 15 yields:

$${FF}_{local} = \frac{\frac{( 1 + z )}{γ ( 1 + β cos {θ}_{local} )} {N}_{remote} {f}_{remote}}{{N}_{local} {f}_{local}} ⇒ \frac{{f}_{remote}}{{f}_{local}} = \frac{γ ( 1 + β cos {θ}_{local} ) {N}_{local} {FF}_{local}}{( 1 + z ) {N}_{remote}} \qquad Eq . 16$$

Similarly for the remote platform, substituting Eq. 8 into Eq. 4 yields:

$${FF}_{remote} = \frac{{f}_{rx , remote}}{{f}_{tx , remote}} = \frac{\frac{( 1 - z )}{γ ( 1 + β cos {θ}_{remote} )} {f}_{tx , local}}{{f}_{tx , remote}} \qquad Eq . 17$$

And substituting Eq. 5 and Eq. 6 into Eq. 17 yields:

$${FF}_{remote} = \frac{\frac{( 1 - z )}{γ ( 1 + β cos {θ}_{remote} )} {N}_{local} {f}_{local}}{{N}_{remote} {f}_{remote}} ⇒ \frac{{f}_{remote}}{{f}_{local}} = \frac{( 1 - z ) {N}_{local}}{γ ( 1 + β cos {θ}_{remote} ) {N}_{remote} {FF}_{remote}} \qquad Eq . 18$$

Now, Eq. 16 is substituted into Eq. 18,

$$\frac{γ ( 1 + β cos {θ}_{local} ) {N}_{local} {FF}_{local}}{( 1 + z ) {N}_{remote}} = \frac{( 1 - z ) {N}_{local}}{γ ( 1 + β cos {θ}_{remote} ) {N}_{remote} {FF}_{remote}} ⇒ {γ}^{2} ( 1 + β cos {θ}_{local} ) ( 1 + β cos {θ}_{remote} ) = \frac{{N}_{local} {N}_{remote} ( 1 - z ) ( 1 + z )}{{N}_{local} {N}_{remote} {FF}_{local} {FF}_{remote}} ⇒ {γ}^{2} ( 1 + β cos {θ}_{local} ) ( 1 + β cos {θ}_{remote} ) = \frac{( 1 - z ) ( 1 + z )}{{FF}_{local} {FF}_{remote}} ⇒ {γ}^{2} ( 1 + β cos {θ}_{local} ) ( 1 + β cos {θ}_{remote} ) = \frac{( 1 - {z}^{2} )}{{FF}_{local} {FF}_{remote}} \qquad Eq . 19$$

Now, Eq. 13 is substituted into Eq. 19,

$$\frac{( 1 + β cos {θ}_{local} ) ( 1 + β cos {θ}_{remote} )}{( 1 - {β}^{2} )} = \frac{( 1 - {z}^{2} )}{{FF}_{local} {FF}_{remote}} \qquad Eq . 20$$

And Eq. 14 is substituted into Eq. 20,

$$\frac{( 1 + β cos {θ}_{local} ) ( 1 + β ( \frac{cos {θ}_{local} + β}{1 + β cos {θ}_{local}} ) )}{( 1 - {β}^{2} )} = \frac{( 1 - {z}^{2} )}{{FF}_{local} {FF}_{remote}} ⇒ \frac{( 1 + βcos {θ}_{local} ) ( 1 + β ( \frac{cos {θ}_{local} + β}{1 + β cos {θ}_{local}} ) )}{( 1 - {β}^{2} )} = \frac{( 1 - {z}^{2} )}{{FF}_{local} {FF}_{remote}} ⇒ \frac{( 1 + β cos {θ}_{local} ) ( 1 + \frac{β ( cos {θ}_{local} + β )}{1 + β cos {θ}_{local}} )}{( 1 - {β}^{2} )} = \frac{( 1 - {z}^{2} )}{{FF}_{local} {FF}_{remote}} ⇒ \frac{( 1 + β cos {θ}_{local} ) + \frac{β ( cos {θ}_{local} + β ) ( 1 + β cos {θ}_{local} )}{1 + β cos {θ}_{local} )}}{( 1 - {β}^{2} )} = \frac{( 1 - {z}^{2} )}{{FF}_{local} {FF}_{remote}} ⇒ \frac{( 1 + β cos {θ}_{local} ) + β ( cos {θ}_{local} + β )}{( 1 - {β}^{2} )} = \frac{( 1 - {z}^{2} )}{{FF}_{local} F {F}_{remote}} ⇒ ( 1 + β cos {θ}_{local} ) + β ( cos {θ}_{local} + β ) = \frac{( 1 - {z}^{2} )}{{FF}_{local} {FF}_{remote}} ( 1 - {β}^{2} ) ⇒ 1 + β cos {θ}_{local} + β cos {θ}_{local} + {β}^{2} = \frac{( 1 - {z}^{2} )}{{FF}_{local} {FF}_{remote}} ( 1 - {β}^{2} ) ⇒ 1 + β cos {θ}_{local} + β cos {θ}_{local} + {β}^{2} = \frac{( 1 - {z}^{2} )}{{FF}_{local} {FF}_{remote}} - \frac{( 1 - {z}^{2} )}{{FF}_{local} {FF}_{remote}} {β}^{2} ⇒ {β}^{2} + \frac{( 1 - {z}^{2} )}{{FF}_{local} {FF}_{remote}} {β}^{2} + 2 β cos {θ}_{local} + 1 - \frac{( 1 - {z}^{2} )}{{FF}_{local} {FF}_{remote}} = 0 ⇒ ( 1 + \frac{( 1 - {z}^{2} )}{{FF}_{local} {FF}_{remote}} ) {β}^{2} + ( 2 cos {θ}_{local} ) β + ( 1 - \frac{( 1 - {z}^{2} )}{{FF}_{local} {FF}_{remote}} ) = 0 \qquad Eq . 21$$

This is a quadratic equation and is readily solved for β to determine the relative velocity of the two oscillators. However, it requires additional information about the system and its direction of motion relative to the line-of-sight between the platforms to first determine θ_{local}. Alternatively, to estimate the slant-range velocity between the two oscillators, we recognize that for v<<c, the dominant Doppler effect is due to the longitudinal motion between the platforms. We thus set θ_{local} to zero and obtain the following result from Eq. 21.

$$( 1 + \frac{( 1 - {z}^{2} )}{{FF}_{local} {FF}_{remote}} ) {β}^{2} + ( 2 cos 0 ) β + ( 1 - \frac{( 1 - {z}^{2} )}{{FF}_{local} {FF}_{remote}} ) = 0 ⇒ ( 1 + \frac{( 1 - {z}^{2} )}{{FF}_{local} {FF}_{remote}} ) {β}^{2} + 2 β + ( 1 - \frac{( 1 - {z}^{2} )}{{FF}_{local} {FF}_{remote}} ) = 0 ⇒ {β}^{2} + \frac{( 1 - {z}^{2} )}{{FF}_{local} {FF}_{remote}} {β}^{2} + 2 β + 1 = \frac{( 1 - {z}^{2} )}{{FF}_{local} {FF}_{remote}} ⇒ {β}^{2} + 2 β + 1 = \frac{( 1 - {z}^{2} )}{{FF}_{local} {FF}_{remote}} - \frac{( 1 - {z}^{2} )}{{FF}_{local} {FF}_{remote}} {β}^{2} ⇒ ( 1 + β ) ( 1 + β ) = \frac{( 1 - {z}^{2} )}{{FF}_{local} {FF}_{remote}} - \frac{( 1 - {z}^{2} )}{{FF}_{local} {FF}_{remote}} {β}^{2} ⇒ ( 1 + β ) ( 1 + β ) = \frac{( 1 - {z}^{2} )}{{FF}_{local} {FF}_{remote}} ( 1 - {β}^{2} ) ⇒ \frac{( 1 + β ) ( 1 + β )}{( 1 - {β}^{2} )} = \frac{( 1 - {z}^{2} )}{{FF}_{local} {FF}_{remote}} ⇒ \frac{( 1 + β ) ( 1 + β )}{( 1 + β ) ( 1 - β )} = \frac{( 1 - {z}^{2} )}{{FF}_{local} {FF}_{remote}} ⇒ \frac{( 1 + β )}{( 1 - β )} = \frac{( 1 - {z}^{2} )}{{FF}_{local} {FF}_{remote}} ⇒ \frac{( 1 - β )}{( 1 + β )} = \frac{{FF}_{local} {FF}_{remote}}{( 1 - {z}^{2} )} ⇒ ( 1 - β ) = \frac{{FF}_{local} {FF}_{remote}}{( 1 - {z}^{2} )} ( 1 + β ) ⇒ ( 1 - β ) = \frac{{FF}_{local} {FF}_{remote}}{( 1 - {z}^{2} )} + \frac{{FF}_{local} {FF}_{remote}}{( 1 - {z}^{2} )} β ⇒ 1 - \frac{{FF}_{local} {FF}_{remote}}{( 1 - {z}^{2} )} = β + \frac{{FF}_{local} {FF}_{remote}}{( 1 - {z}^{2} )} β ⇒ 1 - \frac{{FF}_{local} {FF}_{remote}}{( 1 - {z}^{2} )} = ( 1 + \frac{{FF}_{local} {FF}_{remote}}{( 1 - {z}^{2} )} ) β ⇒ β = \frac{1 - \frac{{FF}_{local} {FF}_{remote}}{( 1 - {z}^{2} )}}{1 + \frac{{FF}_{local} {FF}_{remote}}{( 1 - {z}^{2} )}} \qquad Eq . 22$$

Now Eq. 12 can be substituted into Eq. 22,

$$\frac{v}{c} = \frac{1 - \frac{{FF}_{local} {FF}_{remote}}{( 1 - {z}^{2} )}}{1 + \frac{{FF}_{local} {FF}_{remote}}{( 1 - {z}^{2} )}} ⇒ \hat{v} = \frac{1 - \frac{{FF}_{local} {FF}_{remote}}{( 1 - {z}^{2} )}}{1 + \frac{{FF}_{local} {FF}_{remote}}{( 1 - {z}^{2} )}} c \qquad Eq . 23$$

Eq. 23 provides a solution for the relative velocity of the platforms when the motion between the two platforms is entirely in the direction of the line-of-sight between the platforms. As previously noted, when v<<c, the dominant effect is due to the longitudinal velocity of the platforms and thus Eq. 23 provides a reasonable approximation of the slant-range velocity [symbol] as presented in Eq. 24. The treatment of the redshift term z, will be discussed in more detail in a later section.

$$\hat{sv} ≅ \frac{1 - \frac{{FF}_{local} {FF}_{remote}}{( 1 - {z}^{2} )}}{1 + \frac{{FF}_{local} {FF}_{remote}}{( 1 - {z}^{2} )}} c \qquad Eq . 24$$

### Determining Relative Frequency of the Oscillators

As discussed above, the operating parameters 152, 162 may include relative frequency. One example of calculating the relative frequency is provided below and implemented by processors 150, 160. In embodiments, the same set of system equations may be used to determine the relative frequency of the oscillators on the two platforms.

Rearranging the terms in Eq. 16 yields the following:

$$\frac{{f}_{remote}}{{f}_{local}} = \frac{γ ( 1 + β cos {θ}_{local} ) {N}_{local} {FF}_{local}}{( 1 + z ) {N}_{remote}} ⇒ γ = \frac{{f}_{remote} {N}_{remote} ( 1 + z )}{{f}_{local} {N}_{local} {FF}_{local} ( 1 + β cos {θ}_{local} )} \qquad Eq . 25$$

And rearranging the terms in Eq. 18 yields:

$$\frac{{f}_{remote}}{{f}_{local}} = \frac{( 1 - z ) {N}_{local}}{γ ( 1 + β cos {θ}_{remote} ) {N}_{remote} {FF}_{remote}} ⇒ γ = \frac{{f}_{local} {N}_{local} ( 1 - z )}{{f}_{remote} {N}_{remote} {FF}_{remote} ( 1 + β cos {θ}_{remote} )} \qquad Eq . 26$$

Now Eq. 25 can be substituted into Eq. 26 to yield the following:

$$\frac{{f}_{remote} {N}_{remote} ( 1 + z )}{{f}_{local} {N}_{local} {FF}_{local} ( 1 + β cos {θ}_{local} )} = \frac{{f}_{local} {N}_{local} ( 1 - z )}{{f}_{remote} {N}_{remote} {FF}_{remote} ( 1 + β cos {θ}_{remote} )} ⇒ \frac{{f}_{remote}^{2}}{{f}_{local}^{2}} = \frac{{N}_{local}^{2} {FF}_{local} ( 1 - z ) ( 1 + β cos {θ}_{local} )}{{N}_{remote}^{2} {FF}_{remote} ( 1 + z ) ( 1 + β cos {θ}_{remote} )} ⇒ \frac{{f}_{remote}^{2}}{{f}_{local}^{2}} = \frac{{N}_{local}^{2} {FF}_{local} ( 1 - z ) ( 1 + β cos {θ}_{local} )}{{N}_{remote}^{2} {FF}_{remote} ( 1 + z ) ( 1 + β cos {θ}_{remote} )} ⇒ \frac{{f}_{remote}}{{f}_{local}} = \frac{{N}_{local}}{{N}_{remote}} \sqrt{\frac{{FF}_{local} ( 1 - z ) ( 1 + β cos {θ}_{local} )}{{FF}_{remote} ( 1 + z ) ( 1 + β cos {θ}_{remote} )}} \qquad Eq . 27$$

Now Eq. 14 is substituted into Eq. 27

$$⇒ \frac{{f}_{remote}}{{f}_{local}} = \qquad Eq . 28$$

$$\frac{{N}_{local}}{{N}_{remote}} \sqrt{\frac{{FF}_{local} ( 1 - z ) ( 1 + β cos {θ}_{local} )}{{FF}_{remote} ( 1 + z ) ( 1 + β ( \frac{cos {θ}_{local} + β}{1 + β cos {θ}_{local}} ) )}} ⇒$$

$$\frac{{f}_{remote}}{{f}_{local}} = \frac{{N}_{local}}{{N}_{remote}} \sqrt{\begin{matrix}\frac{{FF}_{local} ( 1 - z ) ( 1 + β cos {θ}_{local} )}{{FF}_{remote} ( 1 + z ) ( 1 + ( \frac{β cos {θ}_{local}}{1 + β cos {θ}_{local}} ) +} \\ ( \frac{{β}^{2}}{1 + β cos {θ}_{local}} ) )\end{matrix}} ⇒$$

$$\frac{{f}_{remote}}{{f}_{local}} = \frac{{N}_{local}}{{N}_{remote}} \sqrt{\begin{matrix}\frac{{FF}_{local} ( 1 - z ) ( 1 + β cos {θ}_{local} )}{{FF}_{remote} ( 1 + z ) ( ( \frac{1 + β cos {θ}_{local}}{1 + β cos {θ}_{local}} ) +} \\ ( \frac{β cos {θ}_{local}}{1 + β cos {θ}_{local}} ) + ( \frac{{β}^{2}}{1 + β cos {θ}_{local}} ) )\end{matrix}} ⇒ \text{}$$

$$\frac{{f}_{remote}}{{f}_{local}} = \frac{{N}_{local}}{{N}_{remote}} \text{} \sqrt{\frac{{FF}_{local} ( 1 - z ) ( 1 + β cos {θ}_{local} )}{{FF}_{remote} ( 1 + z ) ( \frac{1 + β cos {θ}_{local} + β cos {θ}_{local} + {β}^{2}}{1 + β cos {θ}_{local}} )}} ⇒$$

$$\frac{{f}_{remote}}{{f}_{local}} = \frac{{N}_{local}}{{N}_{remote}} \text{} \sqrt{\frac{{FF}_{local} ( 1 - z ) ( 1 + β cos {θ}_{local} )}{{FF}_{remote} ( 1 + z ) ( \frac{1 + 2 β cos {θ}_{local} + {β}^{2}}{1 + β cos {θ}_{local}} )}} ⇒$$

$$\frac{{f}_{remote}}{{f}_{local}} = \frac{{N}_{local}}{{N}_{remote}} \text{} \sqrt{\frac{{FF}_{local} ( 1 - z ) {( 1 + β cos {θ}_{local} )}^{2}}{{FF}_{remote} ( 1 + z ) ( 1 + 2 β cos {θ}_{local} + {β}^{2} )}}$$

The fractional frequency ƒᵣₑₘₒₜₑ/ƒ_{local} is the quantity of interest and relates the frequency of the remote reference oscillator ƒᵣₑₘₒₜₑ to the frequency of the local reference oscillator ƒ_{local}. We now use [symbol] to denote the fractional frequency term and rewrite Eq. 28 to more clearly denote this.

$$\hat{ff} = \frac{{N}_{local}}{{N}_{remote}} \text{} \sqrt{\frac{{FF}_{local} ( 1 - z ) {( 1 + β cos {θ}_{local} )}^{2}}{{FF}_{remote} ( 1 + z ) ( 1 + 2 β cos {θ}_{local} + {β}^{2} )}} \qquad Eq . 29$$

As in the case of the slant-range velocity, additional system information is required to determine the fractional frequency, but we once again set local to zero to provide a reasonable approximation when v<<c. Doing so yields the following from Eq. 29.

$$\hat{ff} ≅ \frac{{N}_{local}}{{N}_{remote}} \text{} \sqrt{\frac{{FF}_{local} ( 1 - z ) {( 1 + β cos {0}_{} )}^{2}}{{FF}_{remote} ( 1 + z ) ( 1 + 2 β cos 0 + {β}^{2} )}} ⇒ \hat{ff} ≅ \frac{{N}_{local}}{{N}_{remote}} \text{} \sqrt{\frac{{FF}_{local} ( 1 - z ) {( 1 + β )}^{2}}{{FF}_{remote} ( 1 + z ) ( 1 + 2 β + {β}^{2} )}} ⇒ \hat{ff} ≅ \frac{{N}_{local}}{{N}_{remote}} \text{} \sqrt{\frac{{FF}_{local} ( 1 - z ) {( 1 + β )}^{2}}{{FF}_{remote} ( 1 + z ) {( 1 + β )}^{2}}} ⇒ \hat{ff} ≅ \frac{{N}_{local}}{{N}_{remote}} \text{} \sqrt{\frac{{FF}_{local} ( 1 - z )}{{FF}_{remote} ( 1 + z )}} \qquad Eq . 30$$

We now have an approximation for the fractional frequency of the remote oscillator relative to the local oscillator that does not require knowing the relative motion of the platforms. The treatment of the redshift term z, will be discussed in more detail in a later section.

### Alternative Notation

The solution derived for the system in FIG. 1 is specific to that system and provides an example implementation of methods disclosed herein. Since the frequency conversion process and the frequency measurement process are dependent on system design, it is desirable to have a more general form of notation to address that, and rely only on the fact that the frequency transmitted and the frequency received by each platform is relatable or measured with respect to frequency generated by the platform's reference oscillator. To express this relationship, we define the following quantities.

FOT_{local}=frequency of transmission (FOT) for the signal from the local platform.

FoA_{local}=frequency of arrival (FOA) for the signal at the local platform.

FOTᵣₑₘₒₜₑ=frequency of transmission (FOT) for the signal from the remote platform.

FoAᵣₑₘₒₜₑ=frequency of arrival (FOA) for the signal at the remote platform.

Furthermore, from the system illustrated in FIG. 1, the following relations can be established.

$${f}_{tx , local} = {FoT}_{local} \qquad Eq . 31$$

$${f}_{rx , local} = {FoA}_{local} \qquad Eq . 32$$

$${f}_{tx , remote} = {FoT}_{remote} \qquad Eq . 33$$

$${f}_{rx , remote} = {FoA}_{remote} \qquad Eq . 34$$

This substitution generalizes the frequency measurement process relative to the method described above. Since there are many ways to measure frequency and frequency relationships, this provides a more general form of implemented methods disclosed herein. Substituting these values into Eq. 3 and Eq. 4 yields the following relations:

$${FF}_{local} = \frac{{FoA}_{local}}{{FoT}_{local}} \qquad Eq . 35$$

$${FF}_{remote} = \frac{{FoA}_{remote}}{{FoT}_{remote}} \qquad Eq . 36$$

Now Eq. 35 and Eq. 36 can be substituted into Eq. 30:

$$⇒ ≅ \frac{{N}_{local}}{{N}_{remote}} \sqrt{( \frac{{FoA}_{local} {FoT}_{remote}}{{FoT}_{local} {FoA}_{remote}} ) ( \frac{1 + z}{1 - z} )} \qquad Eq . 37$$

In practice, knowing the nominal frequency of a remotely located reference oscillator is not particularly useful because it is often particular to that system and does not provide an estimate of the actual fractional frequency offset of the remote oscillator with respect to the local oscillator. Alternatively, a method for determining the fractional frequency offset provides a user of this method with a parameter that can serve as the input to a control system responsible for aligning the frequency of a local oscillator to the frequency of a remote oscillator. One can therefore assert that the nominal frequencies of the two oscillators 106 and 114 are the same and thus the ratio of the frequency multipliers on the respective platforms is equal to the ratio of frequencies of transmission as given here:

$$\frac{{N}_{local}}{{N}_{remote}} = \frac{{FoT}_{local}}{{FoT}_{remote}} \qquad Eq . 38$$

We now substitute Eq. 38 into Eq. 37 to obtain the more generalized result:

$$≅ \frac{{FoT}_{local}}{{FoT}_{remote}} \sqrt{( \frac{{FoA}_{local} {FoT}_{remote}}{{FoT}_{local} {FoA}_{remote}} ) ( \frac{1 + z}{1 - z} )} ⇒ ≅ \sqrt{( \frac{{FoT}_{local}^{2}}{{FoT}_{remote}^{2}} ) ( \frac{{FoA}_{local} {FoT}_{remote}}{{FoT}_{local} {FoA}_{remote}} ) ( \frac{1 + z}{1 - z} )} ⇒ ≅ \sqrt{( \frac{{FoT}_{local} {FoA}_{local}}{{FoT}_{remote} {FoA}_{remote}} ) ( \frac{1 + z}{1 - z} )} \qquad Eq . 39$$

Similarly, the slant-range velocity from Eq. 24 can be expressed in terms of the frequency of transmission and frequency of arrival of the signals transmitted between the platforms by substituting Eq. 35 and Eq. 36 into Eq. 24 as follows:

$$= \frac{1 - \frac{( \frac{{FoA}_{local} {FoA}_{remote}}{{FoT}_{local} {FoT}_{remote}} )}{( 1 - {z}^{2} )}}{1 + \frac{( \frac{{FoA}_{local} {FoA}_{remote}}{{FoT}_{local} {FoT}_{remote}} )}{( 1 - {z}^{2} )}} c \qquad Eq . 40$$

### Treatment of the Redshift Term (z)

The redshift term z in the equations accounts for frequency shift imparted on the signal due to the characteristics of the path traveled by signals. It is described as an equal and opposite frequency shifting effect commonly associated with general relativity and its impact on signals traveling between two different gravitational potentials g. Meaning that the signals traveling in one direction experience a redshift and signals traveling in the opposite direction experience a blue shift. For purposes of this system and in calculating the operating parameters 152 and 160, the redshift term is considered positive when a signal traveling from the local platform to the remote platform experiences a redshift, and negative when a signal traveling from the local platform to the remote platform experiences a blueshift.

For many embodiments of this invention, the redshift term can be estimated by knowing the approximate difference in gravitational potential between the two platforms 102 and 104. Such would be the case when using the method as an input to a system to determine a satellite's orbit. Since satellites often remain at a constant altitude, or have a well-known altitude at any given time, and the ground station also remains at a constant altitude, the redshift term can be calculated from the relative altitudes of each platform at the time the measurements were made. And, in doing so, an accurate estimate of the satellite's slant-range velocity with respect to the ground station can be determined. In turn, that slant-range velocity estimate could feed an orbit determination algorithm that is used to track or control the course of satellites.

In the same example embodiment described in the previous paragraph between a satellite and a ground station, the redshift term (z) might also be set to zero. This would be the case for a system that syntonizes the oscillator on the satellite to an oscillator on the ground so that both oscillators propagate forward at a coordinated rate. Since the same oscillator in space will naturally propagate at a different rate than the same oscillator on the ground (due to general relativity), setting the redshift term to zero effectively negates that effect from the measurement. The fractional frequency estimate made using the method described herein may well serve as an input to a control algorithm for steering the satellite oscillator so that its frequency tracks the ground oscillator's frequency in a coordinated manner. And thus, the same embodiment of the invention may treat the redshift term (z) differently depending on the application and operating parameter it is estimating.

Continuing with the example embodiment of exchanging frequency measurements between an oscillator on a satellite and an oscillator on the ground, yet another operating parameter may be determined. When the oscillator on the satellite and the oscillator on the ground are sufficiently accurate to be considered a primary reference standard, or are controlled in a manner to exhibit such properties, the redshift term (z) can be estimated as an operating parameter. An oscillator exhibiting the properties of a primary reference standard has a frequency that is determined by the reference frame of the oscillator itself. And, as such, the fractional frequency [symbol] of the oscillators is known to be equal to 1. We therefore substitute this quantity into Eq. 39 as follows:

$$Eq . 41$$

$$1 ≅ ( \frac{{FoT}_{local} {FoA}_{local}}{{FoT}_{remote} {FoA}_{remote}} ) ( \frac{1 + z}{1 - z} ) ⇒ {( 1 )}^{2} ≅ ( \frac{{FoA}_{remote} {FoT}_{local}}{{FoT}_{remote} {FoA}_{remote}} ) ( \frac{1 + z}{1 - z} ) ⇒ ( \frac{1 + z}{1 - z} ) ≅ ( \frac{{FoA}_{remote} {FoA}_{remote}}{{FoT}_{local} {FoA}_{local}} ) ⇒ 1 + z ≅ ( \frac{{FoA}_{remote} {FoT}_{remote}}{{FoT}_{local} {FoA}_{local}} ) - ( \frac{{FoA}_{remote} {FoT}_{remote}}{{FoT}_{local} {FoA}_{local}} ) z ⇒ z + ( \frac{{FoA}_{remote} {FoT}_{remote}}{{FoT}_{local} {FoA}_{local}} ) z ≅ ( \frac{{FoA}_{remote} {FoT}_{remote}}{{FoT}_{local} {FoA}_{local}} ) - 1 ⇒ z ( ( \frac{{FoA}_{remote} {FoT}_{remote}}{{FoT}_{local} {FoA}_{local}} ) + 1 ) ≅ ( \frac{{FoA}_{remote} {FoA}_{remote}}{{FoT}_{local} {FoA}_{local}} ) - 1 ⇒ \hat{z} ≅ \frac{( \frac{{FoA}_{remote} {FoT}_{remote}}{{FoT}_{local} {FoA}_{local}} ) - 1}{( \frac{{FoA}_{remote} {FoT}_{remote}}{{FoT}_{local} {FoA}_{local}} ) + 1}$$

Equations 39, 40, and 41 thus provide three operating parameters of interest depending on the embodiment. It is noted that no embodiment of this described method can determine all three operating parameters. Rather, the embodiment is likely designed to estimate the two operating parameters of most interest. It is further noted that, in the example embodiment using primary reference standards on both platforms, all three operating parameters are known but the fractional frequency operating parameter is controlled by system design and therefore not being determined by the method. So too, might another operating parameter be controlled by system design to allow determination of the other two operating parameters.

### The Method

FIG. 5 is a flowchart of a method 500 for determining an operating parameter of a remote reference oscillator on a remote platform to a local reference oscillator on a local platform, both moving independently. Method 500 is implemented using system 100, specifically using processors 150 and 160. Method 500 includes the following steps.

Step 502 includes generating a local reference frequency on the local platform. In an example of step 502, a local reference frequency f_{local} is generated on the local platform using the local reference oscillator.

Step 504 includes generating a transmitted frequency from the local platform. In an example of step 504, a transmitted frequency f_{tx.local} is generated based at least in part on f_{local}.

Step 506 includes sending the transmitted frequency to the remote platform. In an example of step 506, the transmitted frequency f_{tx.local} is sent to the remote platform where it is received as f_{rx.remote} by the remote platform, where f_{rx.remote} is relatable to the reference frequency fᵣₑₘₒₜₑ of the remote reference oscillator.

Step 508 includes generating a remote reference frequency on the remote platform. In an example of step 508, a remote reference frequency fᵣₑₘₒₜₑ is generated on the remote platform using the remote reference oscillator.

Step 510 includes generating a transmitted frequency from the remote platform. In an example of step 510, a transmitted frequency f_{tx.remote} is generated based at least in part on fᵣₑₘₒₜₑ.

Step 512 includes sending the transmitted frequency to the local platform. In an example of step 512, the transmitted frequency f_{tx.remote}, is sent to the local platform where it is received as f_{rx.local} by the local platform and where f_{rx.local} is relatable to the reference frequency f_{local} of the local reference oscillator.

Step 514 includes determining, by the local platform, the locally transmitted frequency FOT_{local} and locally received frequency FoA_{local}, both measured with respect to the local reference oscillator ƒ_{local}.

Step 516 includes determining, by the remote platform, the remotely transmitted frequency FOTᵣₑₘₒₜₑ and the remotely received frequency FoAᵣₑₘₒₜₑ, both measured with respect to the remote reference oscillator ƒᵣₑₘₒₜₑ.

Step 518 includes collecting the transmitted and received frequencies determined by both platforms. In an example of step 518, the information determined by the local platform FOT_{local} and FoA_{local} and the information determined by the remote platform FOTᵣₑₘₒₜₑ and FoAᵣₑₘₒₜₑ is collected in a common location

Step 520 includes determining an operating parameter. In an example of step 520, the slant-range velocity between f_{local} and fᵣₑₘₒₜₑ is determined from FOT_{local}, FoA_{local}, FOTᵣₑₘₒₜₑ, and FoAᵣₑₘₒₜₑ.

Step 522 includes outputting the operating parameter to another system. In embodiments, this may be a system used for controlling a device, such as the oscillator frequency, a system for determining an operational parameter, such as a satellite's orbit, or a system for measuring a quantity, such as the relative gravitational potential of the oscillators.

As disclosed herein, TWFE may be used with oscillators on space-based platforms such as satellites to enhance the synchronization performance between satellites and potentially improve the accuracy of position and velocity solutions provided to users. TWFE may also enable better synchronization performance between mobile users and support a more efficient use of the radio spectrum.

Changes may be made in the above systems and methods without departing from the scope hereof. It should thus be noted that the matter contained in the above description and shown in the accompanying drawings should be interpreted as illustrative and not in a limiting sense. The following claims are intended to cover generic and specific features described herein, as well as all statements of the scope of the present systems and methods, which, as a matter of language, might be said to fall therebetween.

What is claimed is:

1. A method for estimating an operating parameter of a remote reference oscillator on a remote platform relative to a local reference oscillator on a local platform, both platforms moving independently, comprising:
generating a local reference frequency f_{local} on the local platform using the local reference oscillator;
generating a transmitted frequency f_{tx.local} based at least in part on f_{local};
sending the transmitted frequency f_{tx.local} to the remote platform where it is received as f_{rx.remote} by the remote platform, where f_{rx.remote} is relatable to the reference frequency fᵣₑₘₒₜₑ of the remote reference oscillator;
generating a remote reference frequency fᵣₑₘₒₜₑ on the remote platform using the remote reference oscillator;
generating a transmitted frequency f_{tx.remote} based at least in part on fᵣₑₘₒₜₑ;
sending the transmitted frequency f_{tx.remote}, to the local platform where it is received as f_{rx.local} by the local platform and where f_{rx.local} is relatable to the reference frequency f_{local} of the local reference oscillator;
determining, by the local platform, a locally transmitted frequency FoT_{local} and a locally received frequency FoA_{local}, both measured with respect to the local reference oscillator f_{local};
determining, by the remote platform, a remotely transmitted frequency FOTᵣₑₘₒₜₑ and a remotely received frequency FoAᵣₑₘₒₜₑ, both measured with respect to the remote reference oscillator fᵣₑₘₒₜₑ;
collecting the information determined by the local platform FoT_{local} and FoA_{local} and the information determined by the remote platform FOTᵣₑₘₒₜₑ and FoAᵣₑₘₒₜₑ in a common location; and
estimating the operating parameter between f_{local} and fᵣₑₘₒₜₑ from FOT_{local}, FoA_{local}, FOTᵣₑₘₒₜₑ, and FoAᵣₑₘₒₜₑ.

2. The method of claim 1, wherein the transmitted frequencies and the received frequencies experience a frequency shift during transmission according to the equations
$${f}_{rx , local} = \frac{( 1 + z ) {f}_{tx , remote}}{γ ( 1 + β cos {θ}_{remote} )} ,$$
$$and$$
$${f}_{rx , remote} = \frac{( 1 + z ) {f}_{tx , local}}{γ ( 1 + β cos {θ}_{local} )} ,$$
where γ is the Lorentz factor, β is the ratio of the relative oscillator velocities to the speed of light (c), and z is the redshift induced by the signal path, and the terms γ(1+β cos θᵣₑₘₒₜₑ) and γ(1+β cos θ_{local}) account for frequency shifts due to the effects of relative platform motion and generally referred to as relativistic doppler shift and z accounts for frequency shifts due to the effects of the signal path and generally referred to as gravitational redshift.

3. The method of claim 2, wherein the relation between the transmit frequency of the local and remote platforms f_{tx.local} and f_{tx.remote} and their respective reference oscillators, is given by the equations
$${f}_{tx , local} = {FoT}_{local} = {N}_{local} {f}_{local}$$
$$and ,$$
$${f}_{tx , remote} = {FoT}_{remote} = {N}_{remote} {f}_{remote} .$$

4. The method of claim 3, wherein the relation of the received frequency to the transmitted frequency for the local platform FF_{local} and the remote platform FFᵣₑₘₒₜₑ are given by the equations
$$\frac{{f}_{rx , local}}{{f}_{tx , local}} = {FF}_{local} = \frac{{FoA}_{local}}{{FoT}_{local}} ,$$
$$and$$
$$\frac{{f}_{rx , remote}}{{f}_{tx , remote}} = {FF}_{remote} = \frac{{FoA}_{remote}}{{FoT}_{remote}} .$$

5. The method of claim 4, wherein a slant-range velocity sv between the remote reference oscillator fᵣₑₘₒₜₑ and the local reference oscillator f_{local} is estimated according to the equation
$$≅ \frac{1 - \frac{( \frac{{FOA}_{local} {FOA}_{remote}}{{FOT}_{local} {FOT}_{remote}} )}{( 1 - {z}^{2} )}}{1 + \frac{( \frac{{FOA}_{local} {FOA}_{remote}}{{FOT}_{local} {FOT}_{remote}} )}{( 1 - {z}^{2} )}} c$$

6. The method of claim 5, wherein z is assumed to be zero and the slant-range velocity sv between the remote reference oscillator fᵣₑₘₒₜₑ and the local reference oscillator f_{local} is estimated according to the equation
$$≅ \frac{1 - ( \frac{{FOA}_{local} {FOA}_{remote}}{{FOT}_{local} {FOT}_{remote}} )}{1 + ( \frac{{FOA}_{local} {FOA}_{remote}}{{FOT}_{local} {FOT}_{remote}} )} c$$

7. The method of claim 4, wherein the fractional frequency offset ƒƒ of the remote reference oscillator fᵣₑₘₒₜₑ with respect to the local reference oscillator f_{local} is estimated according to the equation
$$≅ \sqrt{( \frac{{FoT}_{local} {FoA}_{local}}{{FoT}_{remote} {FoA}_{remote}} ) ( \frac{1 + z}{1 - z} )}$$

8. The method of claim 7, wherein z is assumed to be zero and the fractional frequency offset ƒƒ of the remote reference oscillator fᵣₑₘₒₜₑ with respect to the local reference oscillator f_{local} is estimated according to the equation
$$≅ \sqrt{( \frac{{FoT}_{local} {FoA}_{local}}{{FoT}_{remote} {FoA}_{remote}} )}$$

9. The method of claim 4, wherein the frequency of the remote reference oscillator fᵣₑₘₒₜₑ and the frequency of the local reference oscillator f_{local} are known to be equal and the redshift of a signal traveling from the local reference oscillator to the remote reference oscillator is estimated according to the equation
$$⇒ \hat{z} ≅ \frac{( \frac{{FoA}_{remote} {FoT}_{remote}}{{FoT}_{local} {FoA}_{local}} ) - 1}{( \frac{{FoA}_{remote} {FoT}_{remote}}{{FoT}_{local} {FoA}_{local}} ) + 1}$$
